(19) United States
(12) Patent Application Publication
(10) Pub. No.: US 2026/0222241 A1
(43) Pub. Date: Jul. 30, 2026

(54) SENSING SYSTEM AND SENSING METHOD

(71) Applicant: Mitsubishi Electric Corporation, Tokyo (JP)

(72) Inventors: Shun KATO, Tokyo (JP); Toshiyuki KURIYAMA, Tokyo (JP)

(21) Appl. No.: 19/146,284

(22) PCT Filed: Jun. 20, 2023
(86) PCT No.: PCT/JP2023/022678

§ 371 Date: Jul. 8, 2025

(51) Int. Cl. H04L 12/28

(52) U.S. Cl. CPC H04L 12/2809; H04L 12/2827

(57) ABSTRACT

A sensing system includes a detection data storage unit configured to store detection data detected by a home appliance installed in a building to be sensed, a detection time of the detection data, and appliance identification information for identifying the home appliance in association with each other, a determination criteria storage unit configured to store determination criteria for determining presence or absence of a person in the building based on the detection data, and a determination processing unit that, when receiving a predetermined specific communication, is configured to determine presence or absence of a person in the building based on the detection data stored by the detection data storage unit, which is the detection data in a determination period based on a reception time at which the specific communication is received, and the determination criteria stored by the determination criteria storage unit.

### TECHNICAL FIELD

The present disclosure relates to a sensing system and a sensing method.

### BACKGROUND ART

Recently, a system is known to output the household population at homes in each area along with information on evacuation centers, based on the results of electricity consumption measured by meters installed in buildings, position information of the meters, and household population information for each area (see, for example, Patent Document 1 to Patent Document 3).

### CITATION LIST

### Patent Documents

Patent Document 1: Japanese Unexamined Patent Application, First Publication No. 2021-157635
Patent Document 2: Japanese Unexamined Patent Application, First Publication No. 2021-179692
Patent Document 3: Japanese Unexamined Patent Application, First Publication No. 2018-190122

### SUMMARY OF INVENTION

### Technical Problem

However, in the related art described above, the home occupancy rate is calculated based on, for example, electricity, water, and gas consumption, and differences in the consumption of appliances installed in the building could affect the accuracy of the calculation of the home occupancy rate.

The present disclosure has been made to solve the above problems, and the object thereof is to provide a sensing system and a sensing method that can accurately sense the presence or absence of a person in a building.

### Solution to Problem

In order to solve the above problem, an aspect of the present disclosure is a sensing system including a detection data storage unit configured to store detection data detected by a home appliance installed in a building to be sensed, a detection time of the detection data, and appliance identification information for identifying the home appliance in association with each other, a determination criteria storage unit configured to store determination criteria for determining presence or absence of a person in the building based on the detection data, and a determination processing unit that, when receiving a predetermined specific communication, is configured to determine presence or absence of a person in the building based on the detection data stored by the detection data storage unit, which is the detection data in a determination period based on a reception time at which the specific communication is received, and the determination criteria stored by the determination criteria storage unit.

In addition, another aspect of the present disclosure is a sensing method of a sensing system including a detection data storage unit configured to store detection data detected by a home appliance installed in a building to be sensed, a detection time of the detection data, and appliance identification information for identifying the home appliance in association with each other, and a determination criteria storage unit configured to store determination criteria for determining presence or absence of a person in the building based on the detection data, the sensing method including: determining, via a determination processing unit, when receiving a predetermined specific communication, presence or absence of a person in the building based on the detection data stored by the detection data storage unit, which is the detection data in a determination period based on a reception time at which the specific communication is received, and the determination criteria stored by the determination criteria storage unit.

### Advantageous Effects of Invention

According to the present disclosure, the presence or absence of a person in a building can be sensed with high accuracy.

### BRIEF DESCRIPTION OF DRAWINGS

FIG. 1 A functional block diagram showing an example of a sensing system according to a first embodiment.

FIG. 2 A diagram showing an example of data in an appliance information storage unit in the first embodiment.

FIG. 3 A diagram showing an example of data in a determination criteria storage unit in the first embodiment.

FIG. 4 A diagram showing an example of data in a detection data storage unit in the first embodiment.

FIG. 5 A diagram showing an example of data in a communication reception time storage unit in the first embodiment.

FIG. 6 A diagram showing an example of data in a sensing result storage unit in the first embodiment.

FIG. 7 A diagram showing an example of data in an aggregation result storage unit in the first embodiment.

FIG. 8 A diagram showing an example of a reception time and a determination period of a specific communication in the first embodiment.

FIG. 9 A diagram showing an example of an operation of the sensing system according to the first embodiment.

FIG. 10 A flowchart showing an example of presence/absence determination processing of a person, performed by a sensing server in the first embodiment.

FIG. 11 A diagram showing an example of aggregation processing of a determination result of the sensing system according to the first embodiment.

FIG. 12 A functional block diagram showing an example of a sensing system according to a second embodiment.

FIG. 13 A diagram showing an example of data in a communication reception time storage unit in the second embodiment.

FIG. 14 A diagram showing an example of an operation of the sensing system according to the second embodiment.

FIG. 15 A functional block diagram showing an example of a sensing system according to a third embodiment,

FIG. 16 A diagram showing an example of data of a building information storage unit in the third embodiment,

FIG. 17 A diagram showing an example of similarity based on a distance in the third embodiment.

FIG. 18 A diagram showing an example of a conversion table of similarities in room types in the third embodiment.

FIG. 19 A diagram showing an example of a relationship between a similarity and a reliability in the third embodiment.

FIG. 20 A flowchart showing an example of presence/absence determination processing of a person, performed by a sensing server in the third embodiment.

FIG. 21 A diagram showing an example of a hardware configuration of each device of the sensing system.

### DESCRIPTION OF EMBODIMENTS

Hereinafter, a sensing system and a sensing method according to an embodiment of the present disclosure will be described with reference to the drawings.

### First Embodiment

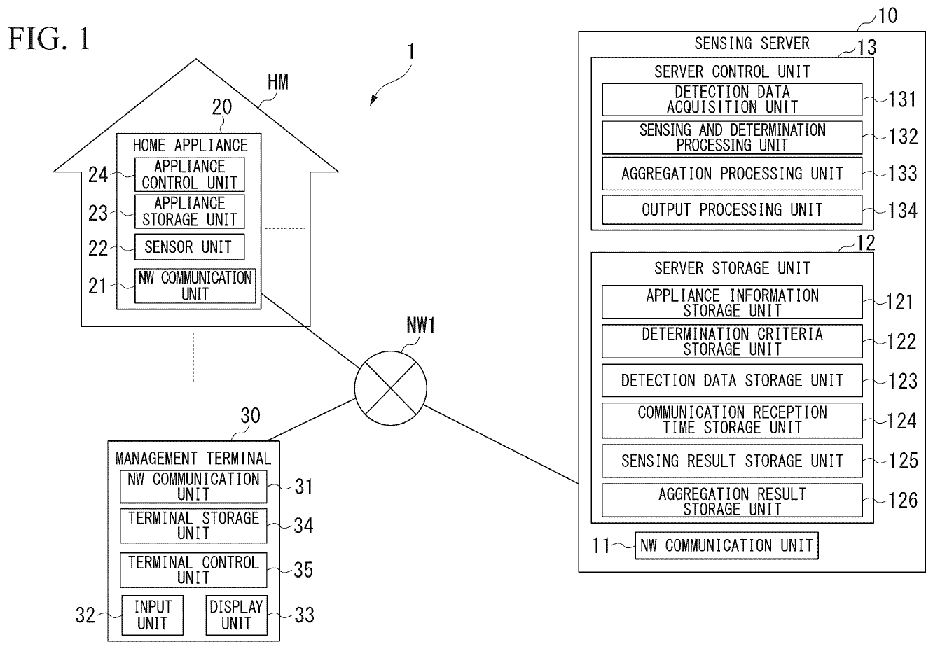

FIG. 1 is a functional block diagram showing an example of a sensing system 1 according to a first embodiment.

The sensing system 1 according to the present embodiment is a system for sensing the presence or absence of a person in a building HM, such as a house, by using a home appliance 20 installed in the building HM.

As shown in FIG. 1, the sensing system 1 includes a sensing server 10, the home appliance 20, and a management terminal 30.

The sensing server 10, the home appliance 20, and the management terminal 30 are connectable to a network NW1 and can communicate with each other via the network NW1.

In the example shown in FIG. 1, for convenience of description, one building HM and one home appliance 20 are described, but the sensing system 1 includes a plurality of buildings HM and a plurality of home appliances 20.

The building HM is a building to be sensed by the sensing system 1, and the home appliance 20 is installed in the building HM.

The home appliance 20 is an appliance that can communicate with the sensing server 10 via the network NW1, and is, for example, an air conditioning appliance such as an air conditioner, a television, a refrigerator, or the like. The home appliance 20 is installed in a room in the building HM.

The home appliance 20 includes a network (NW) communication unit 21, a sensor unit 22, an appliance storage unit 23, and an appliance control unit 24.

The NW communication unit 21 is a functional unit that is implemented by a communication device such as a network adapter. The NW communication unit 21 is connected to the network NW1 and can communicate with the sensing server 10.

The sensor unit 22 includes, for example, various sensors, and detects various types of detection data (various types of sensing data) detected by the home appliance 20. For example, when the home appliance 20 is an air conditioner, the sensor unit 22 includes a temperature sensor, a humidity sensor, a sensor of presence or absence of a person, and the like. In this case, the sensor unit 22 detects, for example, room temperature, indoor humidity, outdoor temperature, outdoor humidity, presence or absence of a person, and the like as detection data. In addition, the detection data may include an operation state of the air conditioner (for example, in operation, stopped, heating operation, cooling operation, dehumidifying operation, and the like).

The appliance storage unit 23 stores various types of information used by the home appliance 20. The appliance storage unit 23 temporarily stores, for example, the detection data detected by the sensor unit 22. In addition, the appliance storage unit 23 stores, for example, a program for performing various controls of the home appliance 20.

The appliance control unit 24 is a functional unit that is implemented by causing a processor including, for example, a central processing unit (CPU) to execute a program stored in the appliance storage unit 23. The appliance control unit 24 acquires the detection data detected by the sensor unit 22 and performs various controls of the home appliance 20 based on the detection data. In addition, the appliance control unit 24 transmits the detection data to the sensing server 10 via the NW communication unit 21 and the network NW1.

The management terminal 30 is a terminal device for managing the sensing system 1. The management terminal 30 is, for example, a personal computer, a tablet terminal, a smartphone, or the like. The management terminal 30 acquires, for example, the sensing result (determination result of presence or absence of a person) of the sensing system 1 and an aggregation result of the sensing result via the network NW1, and outputs the acquired sensing result and aggregation result of the sensing system 1. The management terminal 30 includes an NW communication unit 31, an input unit 32, a display unit 33, a terminal storage unit 34, and a terminal control unit 35.

The NW communication unit 31 is a functional unit that is implemented by a communication device such as a network adapter. The NW communication unit 31 is connected to the network NW1 and can communicate with the sensing server 10.

The input unit 32 is an input device such as a keyboard, a touch screen, a button, and the like. The input unit 32 receives various types of input information in response to an operation of a user (administrator). The input unit 32 outputs the received various types of input information to the terminal control unit 35.

The display unit 33 is, for example, a display device such as a liquid crystal display. The display unit 33 displays, for example, the output information received from the sensing server 10. Here, the output information is, for example, a sensing result (determination result of presence or absence of a person) of the sensing system 1 and an aggregation result of the sensing result.

The terminal storage unit 34 is, for example, a storage device such as a RAM, a flash memory, or a hard disk drive (HDD), and stores various types of information used by the management terminal 30. The terminal storage unit 34 stores, for example, input information from the input unit 32, display information to the display unit 33, transmission/reception information with the sensing server 10, and the like. In addition, the terminal storage unit 34 stores programs for executing various kinds of processing of the management terminal 30.

The terminal control unit 325 is, for example, a functional unit that is implemented by causing a processor including a CPU to execute a program stored in the terminal storage unit 34. The terminal control unit 325 is connected to the sensing server 10 via, for example, the NW communication unit 31 and the network NW1, acquires the sensing result (determination result of presence or absence of a person) of the sensing system 1, and displays the acquired sensing result (determination result of presence or absence of a person) of the sensing system 1 on the display unit 33.

In addition, the terminal control unit 325 transmits a request for aggregation of the sensing results to the sensing server 10 via the NW communication unit 31 and the network NW1, for example, in response to the operation of the input unit 32 by the administrator. In addition, the terminal control unit 325 receives the aggregation result for the aggregation request from the sensing server 10 via the NW communication unit 31 and the network NW1, and displays the received aggregation result on the display unit 33.

The sensing server 10 is a server device connectable to the home appliance 20 and the management terminal 30 via the network NW1. The sensing server 10 senses the presence or absence of a person in the building HM based on, for example, the detection data detected by the home appliance 20.

The sensing server 10 includes an NW communication unit 11, a server storage unit 12, and a server control unit 13.

The NW communication unit 11 is, for example, a functional unit that is implemented by a communication device such as a network adapter. The NW communication unit 11 is connected to the network NW1 and can communicate with the home appliance 20 and the management terminal 30.

The server storage unit 12 is, for example, a storage device such as a RAM, a flash memory, or an HDD, and stores various types of information used by the sensing server 10. The server storage unit 12 stores, for example, a program for executing various types of processing of the sensing server 10. In addition, the server storage unit 12 includes an appliance information storage unit 121, a determination criteria storage unit 122, a detection data storage unit 123, a communication reception time storage unit 124, a sensing result storage unit 125, and an aggregation result storage unit 126.

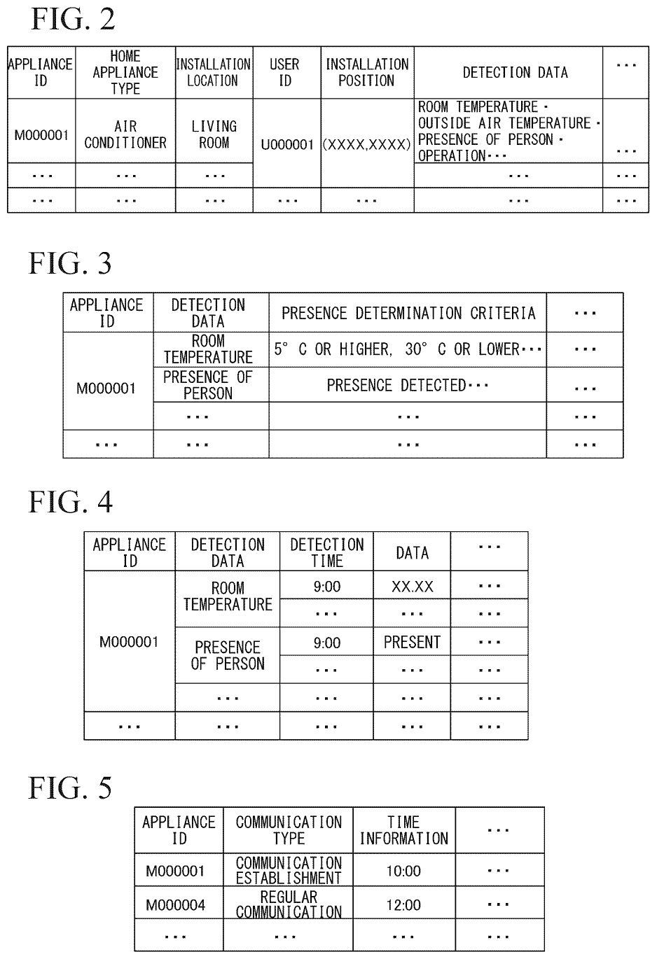

The appliance information storage unit 121 stores information on the home appliance 20 registered in the sensing system 1. Here, an example of data stored in the appliance information storage unit 121 will be described with reference to FIG. 2.

FIG. 2 is a diagram showing an example of data in the appliance information storage unit 121 in the present embodiment.

As shown in FIG. 2, the appliance information storage unit 121 stores an appliance ID, a home appliance type, an installation location, a user ID, an installation position, and detection data in association with each other.

In FIG. 2, the appliance ID is an example of appliance identification information for identifying the home appliance 20. In addition, the appliance type indicates the type of the home appliance 20, and the installation location indicates a location (for example, a room name) in the building HM in which the home appliance 20 is installed. In addition, the user ID is an example of user identification information for identifying a user who owns the home appliance 20. In addition, the installation position is information indicating the position of the building HM, and is, for example, coordinate information based on a latitude and a longitude. In addition, the detection data indicates the type of detection data that can be detected by the home appliance 20.

For example, in the example shown in FIG. 2, the home appliance 20 with the appliance ID “M000001” has the home appliance type of “air conditioner” and the installation location of “living room”. In addition, the user ID of the home appliance 20 is “U000001” and the installation position (latitude and longitude) is “(XXXX, XXXX)”. In addition, the detection data of the home appliance 20 is “room temperature, outside air temperature, presence or absence of person, and operation”.

Returning to the description of FIG. 1, the determination criteria storage unit 122 stores the determination criteria for determining the presence or absence of a person in the building HM based on the detection data detected by the home appliance 20. Here, an example of data stored in the determination criteria storage unit 122 will be described with reference to FIG. 3.

FIG. 3 is a diagram showing an example of data in the determination criteria storage unit 122 in the present embodiment.

As shown in FIG. 3, the determination criteria storage unit 122 stores, for example, the appliance ID, the detection data (type of detection data), and the presence determination criteria in association with each other.

For example, in the example shown in FIG. 3, in the home appliance 20 with the appliance ID “M000001”, when the “room temperature” of the detection data is “5° C. or higher and 30° C. or lower”, it indicates that a person is determined to be present. In addition, in the home appliance 20, when the “presence or absence of a person” of the detection data is “presence detected”, it indicates that a person is determined to be present.

As shown in FIG. 3, the determination criteria storage unit 122 stores the determination criteria for each of the home appliances 20 corresponding to the appliance ID and for each type of the detection data.

Returning to the description of FIG. 1, the detection data storage unit 123 stores the detection data acquired from the home appliance 20 via the network NW1. Here, an example of data stored in the detection data storage unit 123 will be described with reference to FIG. 4.

FIG. 4 is a diagram showing an example of data in the detection data storage unit 123 in the present embodiment.

As shown in FIG. 4, the detection data storage unit 123 stores the appliance ID, the detection data (type of detection data), the detection time, and the data (detection data) in association with each other.

For example, in the example shown in FIG. 4, in the home appliance 20 with the appliance ID “M000001”, the detection data “room temperature” is “XX.XX” at the detection time “9:00”. In addition, the “presence or absence of person” of the detection data indicates “present” at the detection time “9:00”.

As described above, the detection data storage unit 123 stores the detection time and the detection data in association with each other for each of the home appliances 20 corresponding to the appliance ID and for each type of the detection data.

Returning to the description of FIG. 1, the communication reception time storage unit 124 stores time information (reception time) of a specific communication that is a trigger for sensing the presence or absence of a person. Here, an example of data stored by the communication reception time storage unit 124 will be described with reference to FIG. 5.

FIG. 5 is a diagram showing an example of data in the communication reception time storage unit 124 in the present embodiment.

As shown in FIG. 5, the communication reception time storage unit 124 stores the appliance ID, a communication type, and time information in association with each other.

In FIG. 5, the communication type is a specific communication that is predetermined and is the type of specific communication that is a trigger for sensing the presence or absence of a person. The type of specific communication includes, for example, communication establishment indicating an initial communication for the home appliance 20 to establish a communication with another device (for example, the sensing server 10) and a regular communication performed by the home appliance 20 with another device (for example, the sensing server 10) after the initial communication.

In addition, the time information indicates, for example, a reception time at which the sensing server 10 has received the communication.

In the example shown in FIG. 5, “communication establishment” (initial communication) is received at “10:00” as a specific communication from the home appliance 20 with the appliance ID) “M00001”. In addition, the “regular communication” (periodic communication) is received at “12:00” as a specific communication from the home appliance 20 with the appliance ID “M000004”.

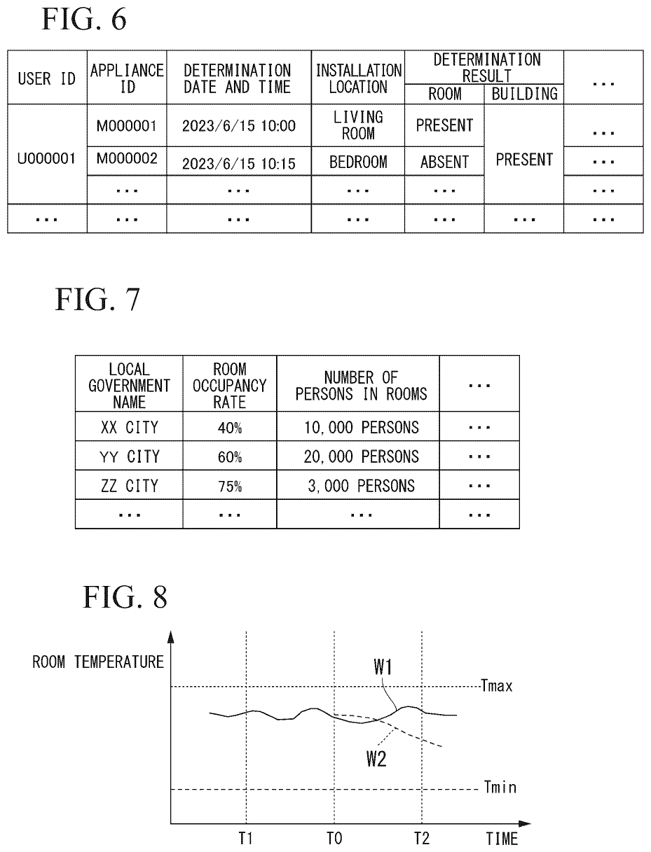

Returning to the description of FIG. 1, the sensing result storage unit 125 stores the sensing result (determination result) of the presence or absence of a person by the sensing server 10. Here, an example of data stored in the sensing result storage unit 125 will be described with reference to FIG. 6.

FIG. 6 is a diagram showing an example of data in the sensing result storage unit 125 in the present embodiment.

As shown in FIG. 6, the sensing result storage unit 125 stores the user ID, the appliance ID, the determination date and time, the installation location, and a determination result in association with each other. Here, the determination result includes a determination result for each room and a determination result for each building HM corresponding to the user ID.

In the example shown in FIG. 6, the determination result corresponding to the user ID “U000001” is the home appliance 20 of which the appliance ID is “M00001”, and the determination date and time of presence or absence of a person is “2023/6/15 10:00” (Jun. 15, 2023, 10:00). In addition, the room for which the determination processing is performed is a “living room”, and the determination result is “present”.

In addition, the determination date and time of presence or absence of a person by the home appliance 20 with the appliance ID “M000002” is “2023/6/15 10:15” (Jun. 15, 2023, 10:15). In addition, the room for which the determination processing is performed is a “bedroom”, and the determination result indicates “absent”.

In addition, the determination result of the entire building HM is “present”.

As described above, the sensing result storage unit 125 stores the determination result of presence or absence of a person for each user (building HM) and stores the determination result of presence or absence of a person for each room of the building HM.

Returning to the description of FIG. 1, the aggregation result storage unit 126 stores an aggregation result obtained by an aggregation processing unit 133, which will be described later, aggregating the determination result of presence or absence of a person. The aggregation result storage unit 126 stores, for example, an aggregation result in which a determination result of presence or absence of a person is aggregated for each predetermined area. Here, an example of data stored in the aggregation result storage unit 126 will be described with reference to FIG. 7.

FIG. 7 is a diagram showing an example of data in the aggregation result storage unit 126 in the present embodiment.

As shown in FIG. 7, the aggregation result storage unit 126 stores a local government name, a room occupancy rate, and the number of persons in the room in association with each other.

In the example shown in FIG. 7, the room occupancy rate of a local government name “XX City” is “40%”, and the number of persons in the rooms is “10,000”. In addition, the room occupancy rate is “60%” and the number of persons in the rooms is “20,000” when the local government name is “YY City” The aggregation result storage unit 126 may store display information as shown in FIG. 7.

Returning to the description of FIG. 1, the server control unit 13 is a functional unit that is implemented by causing a processor including, for example, a CPU to execute a program stored in the server storage unit 12. The server control unit 13 includes a detection data acquisition unit 131, a sensing and determination processing unit 132, an aggregation processing unit 133, and an output processing unit 134.

The detection data acquisition unit 131 acquires the detection data from each home appliance 20 via the NW communication unit 11, and stores the acquired detection data in the detection data storage unit 123 in association with the detection time. For example, as shown in FIG. 4, the detection data acquisition unit 131 stores the appliance ID of the home appliance 20, the type of the detection data, the detection time, and the detection data in association with each other.

The detection data acquisition unit 131 may periodically acquire the detection data from each home appliance 20, or may acquire the detection data from the home appliance 20 corresponding to a specific communication when the specific communication described below is received.

When receiving a predetermined specific communication, the sensing and determination processing unit 132 (an example of a determination processing unit) determines the presence or absence of a person in the building HM based on the detection data stored by the detection data storage unit 123, which is the detection data in a determination period based on a reception time at which the specific communication is received, and the determination criteria stored by the determination criteria storage unit 122.

Here, the determination period is, for example, a range of 1 hour before and after a reception time at which the specific communication is received. For example, when the reception time is 10:00, the determination period is a period from 9:00 to 11:00.

In addition, the specific communication is a communication that is a trigger for sensing the presence or absence of a person, and includes, for example, a communication in which a person is considered to have entered and left the building HM (or each room). The specific communication includes, for example, an initial communication for the home appliance 20 to establish a communication with the sensing server 10 (another device). That is, when an initial communication for the home appliance 20 to establish a communication with the sensing server 10 is received from the home appliance 20 as a specific communication, the sensing and determination processing unit 132 determines the presence or absence of a person in the building HM.

In addition, the specific communication includes, for example, a regular communication between the home appliance 20 and the sensing server 10 after the initial communication described above. That is, when the regular communication between the home appliance 20 and the sensing server 10 is received from the home appliance 20 as a specific communication, the sensing and determination processing unit 132 determines the presence or absence of a person in the building HM.

The sensing and determination processing unit 132 may determine that a specific communication is received when a regular communication is received from the home appliance 20 and a sudden change occurs in the detection data. Here, the case where a sudden change occurs in the detection data is, for example, a case where a change per unit time equal to or greater than a threshold occurs in the detection data.

FIG. 8 is a diagram showing an example of a reception time and a determination period of a specific communication in the present embodiment.

In FIG. 8, the home appliance 20 is an air conditioner, and the detection data is a room temperature. That is, in the graph shown in FIG. 8, the vertical axis indicates room temperature, and the horizontal axis indicates time.

In addition, in FIG. 8, a time T0 indicates a reception time of a specific communication, and a period from a time T1 to a time T2 is a determination period. The sensing and determination processing unit 132 acquires the detection data of the determination period (period from time T1 to time T2) corresponding to the specific communication received by the home appliance 20 from the detection data storage unit 123, and compares the acquired detection data with the determination criteria stored in the determination criteria storage unit 122, When the detection data (waveform W1) in the determination period satisfies the determination criteria for determining that a person is present in the room, the sensing and determination processing unit 132 determines that a person is present in the room. In addition, when the detection data in the determination period does not satisfy the determination criteria for determining that a person is present, the sensing and determination processing unit 132 determines that a person is absent.

In FIG. 8, the waveform W1 indicates a state in which the air conditioner is operating in a state in which the user is absent, and the room temperature is periodically changed. In addition, a waveform W2 shows an example in which the user operates the air conditioner and the room temperature changes. In a case of the waveform W2, the sensing and determination processing unit 132 determines that a person is present based on the determination criteria.

In addition, in FIG. 8, a room temperature Tmax and a room temperature Tmin show an example of determination criteria. When the room temperature, which is the detection data, is less than the room temperature Tmin or exceeds the room temperature Tmax, the sensing and determination processing unit 132 determines that a person is absent.

In addition, when a plurality of specific communications are received in a predetermined certain period, the sensing and determination processing unit 132 determines the presence or absence of a person in the building HM by using detection data in a determination period based on a median value or the most recent value among a plurality of reception times.

The sensing and determination processing unit 132 stores the determination result of the presence or absence of a person in the sensing result storage unit 125. For example, as shown in FIG. 6, the sensing and determination processing unit 132 stores the determination result in the sensing result storage unit 125 for each room and each building HM.

The aggregation processing unit 133 generates an aggregation result in which the determination results determined by the sensing and determination processing unit 132 are aggregated for each predetermined area. The aggregation processing unit 133 aggregates, for example, the determination results (sensing results) stored in the sensing result storage unit 125 for each local government and generates, for example, display information as shown in FIG. 7.

The aggregation processing unit 133 stores the aggregation result in the aggregation result storage unit 126.

The output processing unit 134 outputs the determination result determined by the sensing and determination processing unit 132 and the aggregation result aggregated by the aggregation processing unit 133 to the management terminal 30. The output processing unit 134 outputs the determination result stored in the sensing result storage unit 125 to the management terminal 30 that is connectable to the sensing server 10 via the network NW1. In addition, the output processing unit 134 outputs the aggregation result stored in the aggregation result storage unit 126, which is shown in FIG. 7, to the management terminal 30.

Next, an operation of the sensing system 1 according to the present embodiment will be described with reference to the drawings.

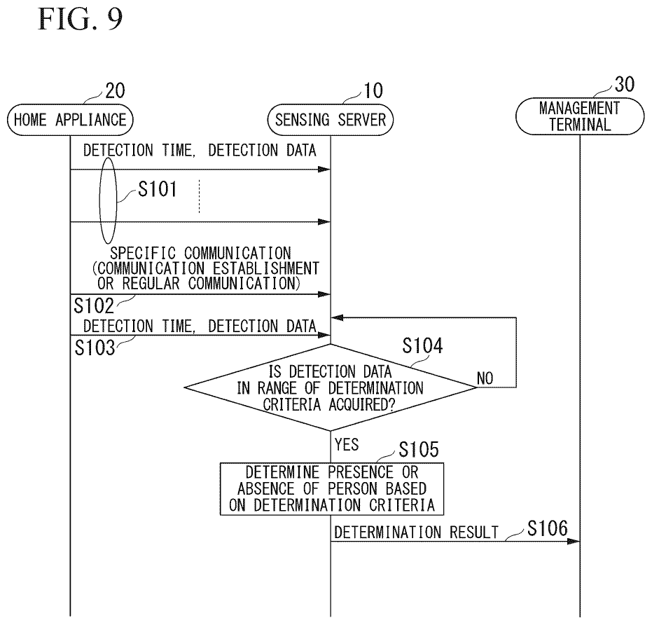

FIG. 9 is a diagram showing an example of an operation of the sensing system 1 according to the present embodiment.

As shown in FIG. 9, in the sensing system 1 according to the present embodiment, the home appliance 20 periodically transmits the detection time and the detection data to the sensing server 10 (step S101). The detection data acquisition unit 131 of the sensing server 10 acquires the detection time and the detection data from the home appliance 20 via the NW communication unit 11, and stores the acquired detection time and the detection data in the detection data storage unit 123 as shown in FIG. 4, for example.

The detection data acquisition unit 131 may acquire the appliance ID of the home appliance 20 together with the detection time and the detection data. The detection data acquisition unit 131 stores the appliance ID of the home appliance 20 in the detection data storage unit 123 in association with the detection time and the detection data.

Next, the home appliance 20 transmits the specific communication (notification establishment or regular communication) to the sensing server 10 (step S102). The sensing and determination processing unit 132 of the sensing server 10 determines whether or not the communication received from the home appliance 20 is the specific communication, and when the specific communication is received, starts the sensing determination processing with the specific communication as a trigger.

The detection data acquisition unit 131 subsequently acquires the detection time and the detection data from the home appliance 20 (step S103), and the sensing and determination processing unit 132 determines whether or not the detection data in the range of the determination criteria is acquired (step S104). The sensing and determination processing unit 132 determines whether or not the detection data in a determination period (for example, a period of 1 hour before and after the reception time) based on the reception time of a specific notification is acquired. When the detection data of the determination period is acquired (YES in step S104), the sensing and determination processing unit 132 advances the processing to step S105. In addition, when the detection data of the determination period is not acquired (NO in step S104), the sensing and determination processing unit 132 returns the processing to step S103.

In step S105, the sensing and determination processing unit 132 determines the presence or absence of a person based on the determination criteria. The sensing and determination processing unit 132 determines the presence or absence of a person in the building HM (or room) in which the home appliance 20 is installed, for example, based on whether or not the detection data of the determination period stored in the detection data storage unit 123 satisfies the presence determination criteria stored in the determination criteria storage unit 122.

Next, the output processing unit 134 of the sensing server 10 transmits the determination result to the management terminal 30 (step S106). The output processing unit 134 transmits the determination result to the management terminal 30 via the NW communication unit 11, and the management terminal 30 displays the determination result on, for example, the display unit 33.

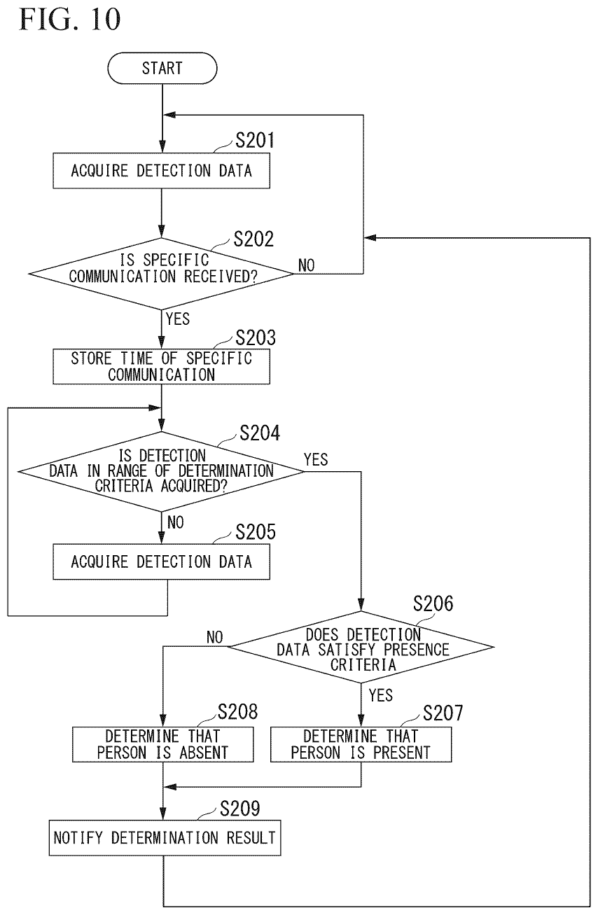

Next, details of the sensing determination processing in the sensing server 10 will be described with reference to FIG. 10.

FIG. 10 is a flowchart showing an example of the presence determination processing of a person by the sensing server 10 in the present embodiment.

As shown in FIG. 10, the detection data acquisition unit 131 of the sensing server 10 periodically acquires the detection data (step S201). The detection data acquisition unit 131 acquires the detection data and the detection time from the home appliance 20 via the NW communication unit 11, and stores the appliance ID of the home appliance 20 in association with the detection data and the detection time in the detection data storage unit 123, for example, as shown in FIG. 4.

Next, the sensing and determination processing unit 132 of the sensing server 10 determines whether or not a specific communication is received (step S202. The sensing and determination processing unit 132 determines whether or not an initial communication or regular communication from the home appliance 20 is received. The sensing and determination processing unit 132 may determine that a specific communication is received by the reception of a regular communication and a sudden change in the detection data.

When the specific communication is received from the home appliance 20 (YES in step S202), the sensing and determination processing unit 132 advances the processing to step S203. In addition, when the specific communication is not received from the home appliance 20 (NO in step S202), the sensing and determination processing unit 132 returns the processing to step S201.

In step S203, the sensing and determination processing unit 132 stores the time of the specific communication. For example, as shown in FIG. 5, the sensing and determination processing unit 132 stores the appliance ID of the home appliance 20 in association with the reception time (time information) in the communication reception time storage unit 124.

Next, the sensing and determination processing unit 132 determines whether or not the detection data in the range of the determination criteria is acquired (step S204). The sensing and determination processing unit 132 determines whether or not the detection data in a determination period (for example, a period of 1 hour before and after the reception time) based on the reception time of the specific communication is acquired. When the detection data in the determination period is acquired (YES in step S204), the sensing and determination processing unit 132 advances the processing to the step S206. In addition, when the detection data in the determination period is not acquired (NO in step S204), the sensing and determination processing unit 132 advances the processing to step S205.

In step S205, the detection data acquisition unit 131 acquires the detection data, and returns the processing to step S204. As shown in FIG. 4, the detection data acquisition unit 131 stores the appliance ID of the home appliance 20 in association with the acquired detection data and the detection time in the detection data storage unit 123 each other. Here, the detection data acquisition unit 131 repeats the acquisition of the detection data until the detection data of the determination period is acquired.

In step S206, the sensing and determination processing unit 132 determines whether or not the detection data satisfies presence criteria. The sensing and determination processing unit 132 acquires the determination criteria corresponding to the appliance ID of the home appliance 20 from the determination criteria storage unit 122, and acquires the detection data and the detection time corresponding to the appliance ID of the home appliance 20 stored in the detection data storage unit 123 in the determination period. The sensing and determination processing unit 132 determines whether or not the detection data in the determination period satisfies the presence criteria, which is the determination criteria. When the detection data satisfies the presence criteria (YES in step S206), the sensing and determination processing unit 132 advances the processing to step S207. In addition, when the detection data does not satisfy the presence criteria (NO in step S206), the sensing and determination processing unit 132 advances the processing to step S208.

In step S207, the sensing and determination processing unit 132 determines that a person is present in the building HM (or room) in which the home appliance 20 is installed. The sensing and determination processing unit 132 stores the determination result in the sensing result storage unit 125, for example, as shown in FIG. 6. After the processing of step S207, the sensing and determination processing unit 132 advances the processing to step S209.

In addition, in step S208, the sensing and determination processing unit 132 determines that a person is absent, that is, that there is no person present in the building HM (or room) in which the home appliance 20 is installed. The sensing and determination processing unit 132 stores the determination result in the sensing result storage unit 125, for example, as shown in FIG. 6. After the processing of step S208, the sensing and determination processing unit 132 advances the processing to step S209.

In step S209, the output processing unit 134 of the sensing server 10 notifies the management terminal 30 of the determination result. The output processing unit 134 transmits the determination result corresponding to the appliance ID of the home appliance 20 stored in the sensing result storage unit 125 to the management terminal 30 via the NW communication unit 11. After the processing of step S209, the output processing unit 134 returns the processing to step S201.

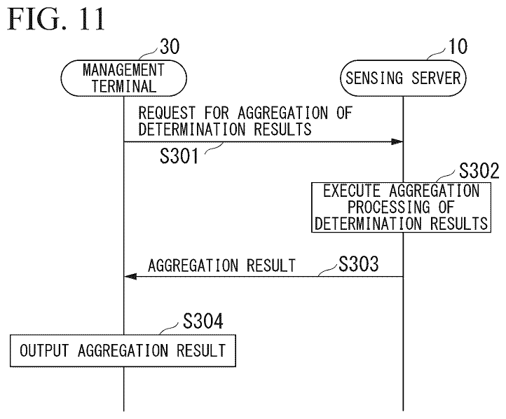

Next, the aggregation processing of the sensing results (determination results) of the sensing system 1 according to the present embodiment will be described with reference to FIG. 11.

FIG. 11 is a diagram showing an example of the aggregation processing of the determination results of the sensing system 1 according to the present embodiment.

As shown in FIG. 11, first, the management terminal 30 transmits a request for aggregation of the determination results to the sensing server 10 (step S301). The terminal control unit 35 of the management terminal 30 transmits a request for aggregation of the determination results to the sensing server 10 via the NW communication unit 31 in response to the operation of the input unit 32 by the administrator.

Next, the aggregation processing unit 133 of the sensing server 10 executes the aggregation processing of the determination results (step S302). The aggregation processing unit 133 aggregates the determination results stored in the sensing result storage unit 125 for each local government based on, for example, the installation position of the home appliance 20 stored in the appliance information storage unit 121, and generates, for example, a room occupancy rate and the number of persons in the room for each local government. The aggregation processing unit 133 stores the aggregation result in the aggregation result storage unit 126.

Next, the output processing unit 134 of the sensing server 10 transmits the aggregation result to the management terminal 30 (step S303). The output processing unit 134 transmits the aggregation result stored in the aggregation result storage unit 126 to the management terminal 30 via the NW communication unit 11.

Next, the management terminal 30 outputs the aggregation result (step S304). The terminal control unit 35 displays the aggregation result received via the NW communication unit 31 on the display unit 33. For example, the display unit 33 displays the aggregation result as shown in FIG. 7.

As described above, the sensing system 1 according to the present embodiment includes the detection data storage unit 123, the determination criteria storage unit 122, and the sensing and determination processing unit 132 (determination processing unit). The detection data storage unit 123 stores the detection data detected by the home appliance 20 installed in the building HM to be sensed, the detection time of the detection data, and the appliance identification information (for example, the appliance ID) for identifying the home appliance 20 in association with each other. The determination criteria storage unit 122 stores determination criteria for determining the presence or absence of a person in the building HM by the detection data. When a predetermined specific communication is received, the sensing and determination processing unit 132 determines the presence or absence of a person in the building based on the detection data stored by the detection data storage unit 123, which is the detection data in a determination period based on a reception time at which the specific communication is received, and the determination criteria stored by the determination criteria storage unit 122.

Accordingly, in the sensing system 1 according to the present embodiment, since the presence or absence of a person in the building HM is determined by the detection data detected by the home appliance 20, the presence or absence of a person in the building HM can be sensed with high accuracy regardless of the magnitude of the power consumption of the home appliance 20. The sensing system 1 according to the present embodiment can sense the presence or absence of a person in the building HM with higher accuracy than the related art in which electricity, water, and gas are used.

In addition, in the present embodiment, when the sensing and determination processing unit 132 receives, as a specific communication, an initial communication for the home appliance 20 to establish a communication with another device (for example, the sensing server 10) from the home appliance 20, the sensing and determination processing unit 132 determines the presence or absence of a person in the building HM. The initial communication occurs, for example, when setting up a connection with the sensing server 10, when the power supply to the home appliance 20 from a power source such as an outlet is interrupted (for example, due to a power outage, and the like), or when the user manually or automatically initializes the network settings.

Accordingly, when an abnormality such as a restart of the home appliance 20 occurs, the sensing system 1 according to the present embodiment can quickly and accurately sense the presence or absence of a person in the building HM.

In addition, in the present embodiment, when the sensing and determination processing unit 132 receives, as a specific communication, a regular communication between the home appliance 20 and another device (for example, the sensing server 10) from the home appliance 20, the sensing and determination processing unit 132 determines the presence or absence of a person in the building HM.

Accordingly, the sensing system 1 according to the present embodiment can periodically and accurately sense the presence or absence of a person in the building HM.

In addition, in the present embodiment, when the sensing and determination processing unit 132 receives a regular communication from the home appliance 20 and a change per unit time equal to or greater than the threshold occurs in the detection data, the sensing and determination processing unit 132 determines that a specific communication is received and determines the presence or absence of a person in the building HM.

Accordingly, in the sensing system 1 according to the present embodiment, for example, when a person enters and leaves the building HM, when a person directly operates the home appliance 20, or the like, a sudden temporal change occurs in the detection data. Therefore, it is possible to accurately sense the presence or absence of a person in the building HM by using this change as a trigger. That is, the sensing system 1 according to the present embodiment can sense the presence or absence of a person in the building HM with high accuracy at an appropriate timing.

In addition, in the present embodiment, when a plurality of specific communications are received in a predetermined certain period, the sensing and determination processing unit 132 determines the presence or absence of a person in the building HM by using detection data in a determination period based on a median value or the most recent value among a plurality of reception times.

Accordingly, when a plurality of specific communications occur in a certain period, the sensing system 1 according to the present embodiment can appropriately sense the presence or absence of a person in the building HM.

In addition, the sensing system 1 according to the present embodiment includes the sensing server 10 (server device) connectable to the home appliance 20 via the network NW1. The sensing server 10 includes the detection data storage unit 123, the determination criteria storage unit 122, the sensing and determination processing unit 132, and the output processing unit 134. The output processing unit 134 outputs the determination result determined by the sensing and determination processing unit 132 to the management terminal 30 (terminal device) connectable to the sensing server 10 via the network NW1.

Accordingly, the sensing system 1 according to the present embodiment can appropriately output the determination result (sensing result) of the presence or absence of a person in the building HM from the sensing server 10 to the management terminal 30 (terminal device). Therefore, the sensing system 1 according to the present embodiment can effectively utilize the determination result (sensing result) of the presence or absence of a person in the building HM.

In addition, the sensing system 1 (sensing server 10) according to the present embodiment includes the aggregation processing unit 133 that generates an aggregation result in which the determination results determined by the sensing and determination processing unit 132 are aggregated for each predetermined area. The output processing unit 134 outputs the aggregation result to the management terminal 30.

As a result, the sensing system 1 according to the present embodiment can easily and accurately obtain, for example, an aggregation result in which the determination results of the presence or absence of a person are aggregated for each area when a disaster occurs. In addition, the sensing system 1 according to the present embodiment can utilize the aggregation result as statistical data such as disaster prevention information and an activity status for an event.

In addition, the sensing method according to the present embodiment is a sensing method of the sensing system 1 including the detection data storage unit 123 and the determination criteria storage unit 122, and includes a determination processing step. The detection data storage unit 123 stores the detection data detected by the home appliance 20 installed in a building to be sensed, the detection time of the detection data, and the appliance identification information for identifying the home appliance 20 in association with each other. The determination criteria storage unit 122 stores determination criteria for determining the presence or absence of a person in the building by the detection data. In the determination processing step, when the sensing and determination processing unit 132 receives a predetermined specific communication, the detection data storage unit 123 determines the presence or absence of a person in the building based on the detection data stored by the detection data storage unit 123, which is the detection data in a determination period based on a reception time at which the specific communication is received, and the determination criteria stored by the determination criteria storage unit 122.

As a result, the sensing method according to the present embodiment has the same effect as the sensing system 1 described above, and it is possible to accurately sense the presence or absence of a person in the building HM regardless of the magnitude of the power consumption of the home appliance 20.

### Second Embodiment

Next, a sensing system 1a according to a second embodiment will be described with reference to the drawings.

In the second embodiment, a modification example of a case where the specific communication is received from an external device (for example, disaster prevention server 40) will be described.

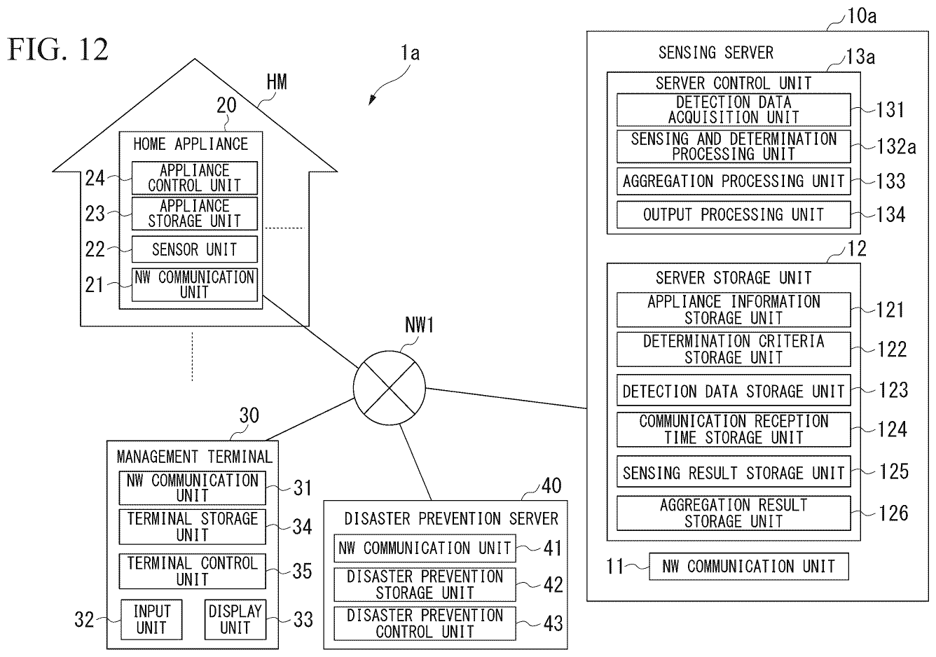

FIG. 12 is a functional block diagram showing an example of the sensing system 1a according to the second embodiment.

As shown in FIG. 12, the sensing system 1a includes a sensing server 10a, the home appliance 20, the management terminal 30, and a disaster prevention server 40.

In FIG. 12, the same components as those in the components shown in FIG. 1 described above are designated by the same reference numerals, and the description thereof will be omitted.

The disaster prevention server 40 is, for example, a server device that notifies disaster and evacuation information when a disaster such as an earthquake or a meteorological disaster occurs. In the present embodiment, the disaster prevention server 40 is an example of an external device that can notify the sensing server 10a of a specific notification communication for notifying specific notification information (for example, disaster and evacuation information) via the network NW1.

The disaster prevention server 40 includes an NW communication unit 41, a disaster prevention storage unit 42, and a disaster prevention control unit 43.

The NW communication unit 41 is a functional unit that is implemented by, for example, a communication device such as a network adapter. The NW communication unit 41 is connected to the network NW1 and can communicate with the sensing server 10a.

The disaster prevention storage unit 42 is, for example, a storage device such as a RAM, a flash memory, or an HDD, and stores various types of information used by the disaster prevention server 40. The disaster prevention storage unit 42 stores, for example, a program for executing various types of processing of the disaster prevention server 40.

The disaster prevention control unit 43 is a functional unit that is implemented by causing a processor including, for example, a CPU to execute a program stored in the disaster prevention storage unit 42. The disaster prevention control unit 43 transmits the disaster and evacuation information to the sensing server 10a via the N W communication unit 41, for example, when a disaster occurs or when there is a possibility that a disaster occurs.

The sensing server 10a is a server device connectable to the home appliance 20 and the management terminal 30 via the network NW1. The sensing server 10a includes the NW communication unit 11, the server storage unit 12, and a server control unit 13a.

In the present embodiment, the communication reception time storage unit 124 of the server storage unit 12 includes notification of disaster and evacuation information as a specific communication.

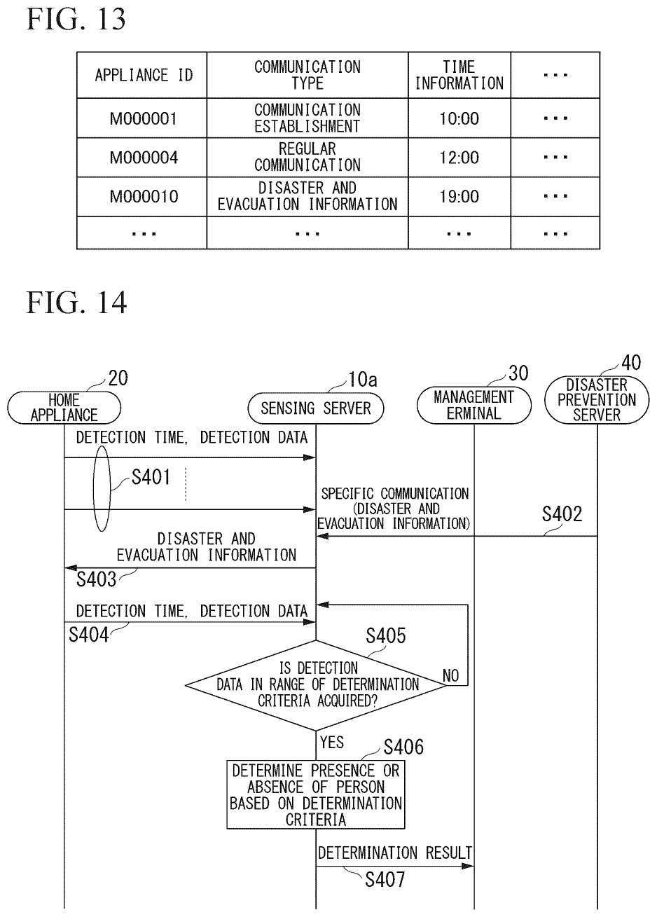

FIG. 13 is a diagram showing an example of data in the communication reception time storage unit 124 in the present embodiment.

As shown in FIG. 13, the communication reception time storage unit 124 stores “disaster and evacuation information” as communication type.

Returning to the description of FIG. 12, the server control unit 13a is a functional unit that is implemented by causing a processor including, for example, a CPU to execute a program stored in the server storage unit 12. The server control unit 13a includes the detection data acquisition unit 131, a sensing and determination processing unit 132a, the aggregation processing unit 133, and the output processing unit 134.

When a predetermined specific communication is received, the sensing and determination processing unit 132a (an example of a determination processing unit) determines the presence or absence of a person in the building HM based on the detection data stored by the detection data storage unit 123, which is the detection data in a determination period based on a reception time at which the specific communication is received, and the determination criteria stored by the determination criteria storage unit 122. The sensing and determination processing unit 132a executes the same processing as the sensing and determination processing unit 132 of the first embodiment described above.

The sensing and determination processing unit 132a further determines the presence or absence of a person in the building HM when a specific notification communication for notifying specific notification information is received as a specific communication from an external device (disaster prevention server 40) different from the home appliance 20. Here, the specific notification information is, for example, a notification of disaster and evacuation information notified by the disaster prevention server 40. Since the processing after receiving the notification of the disaster and evacuation information as the specific communication is the same as the sensing and determination processing unit 132 of the first embodiment, the description thereof will be omitted here.

Next, an operation of the sensing system 1a according to the present embodiment will be described with reference to the drawings.

FIG. 14 is a diagram showing an example of an operation of the sensing system 1a according to the present embodiment.

In FIG. 14, the home appliance 20 periodically transmits the detection time and the detection data to the sensing server 10a (step S401). The detection data acquisition unit 131 of the sensing server 10a acquires the detection time and the detection data from the home appliance 20 via the NW communication unit 11, and stores the acquired detection time and the detection data in the detection data storage unit 123 as shown in FIG. 4, for example.

Next, the disaster prevention server 40 transmits the disaster and evacuation information to the sensing server 10a as a specific communication (step S402). The disaster prevention control unit 43 of the disaster prevention server 40 transmits the disaster and evacuation information to the sensing server 10a via the NW communication unit 41. The sensing and determination processing unit 132a of the sensing server 10a determines whether or not the communication received from the disaster prevention server 40 is a specific communication (disaster and evacuation information), and when the specific communication (disaster and evacuation information) is received, starts the sensing determination processing with the specific communication as a trigger.

Next, the server control unit 13a of the sensing server 10a transmits the disaster and evacuation information to each home appliance 20 via the NW communication unit 11 (step S403).

Since the processing of step S404 to step S407 that follows is the same as the processing of step S103 to step S106 shown in FIG. 9, the description thereof will be omitted here.

In addition, the details of the sensing determination processing in the sensing server 10a of the present embodiment are the same as the processing shown in FIG. 10 except that the sensing and determination processing unit 132a determines the disaster and evacuation information from the disaster prevention server 40 as a specific notification in step S202 shown in FIG. 10, and thus the description thereof will be omitted here.

In addition, since the aggregation processing of the sensing result (determination result) of the sensing system 1a according to the present embodiment is the same as that of the first embodiment shown in FIG. 11, the description thereof will be omitted here.

As described above, the sensing system 1a according to the present embodiment includes the detection data storage unit 123, the determination criteria storage unit 122, and the sensing and determination processing unit 132a (determination processing unit).

Accordingly, the sensing system 1a according to the present embodiment exhibits the same effect as the first embodiment, and can accurately sense the presence or absence of a person in the building HM regardless of the magnitude of the power consumption of the home appliance 20.

In addition, in the present embodiment, when receiving, as a specific communication, a specific notification communication for notifying the specific notification information (for example, disaster and evacuation information) from an external device (disaster prevention server 40) different from the home appliance 20, the sensing and determination processing unit 132a determines the presence or absence of a person in the building.

Accordingly, since the sensing system 1a according to the present embodiment uses the specific notification communication received from the external device (disaster prevention server 40) as a specific communication, when the difference that cannot be sensed by the home appliance 20 occurs (for example, when a disaster occurs or the like), it is possible to quickly sense the presence or absence of a person in the building HM.

The specific notification communication is not limited to the notification of the disaster and evacuation information, and may be, for example, event information such as concerts or events, or information about approaching or moving away from the appliance of family or friends. The specific notification communication may be a notification of other information as long as the information affects the behavior of the user who uses the home appliance 20.

### Third Embodiment

Next, a sensing system 1b according to a third embodiment will be described with reference to the drawings.

In the third embodiment, a modification example will be described in which, when data is missing in the detection data detected by the home appliance 20, the detection data of an environment similar to the building HM (or room) is used as a complement.

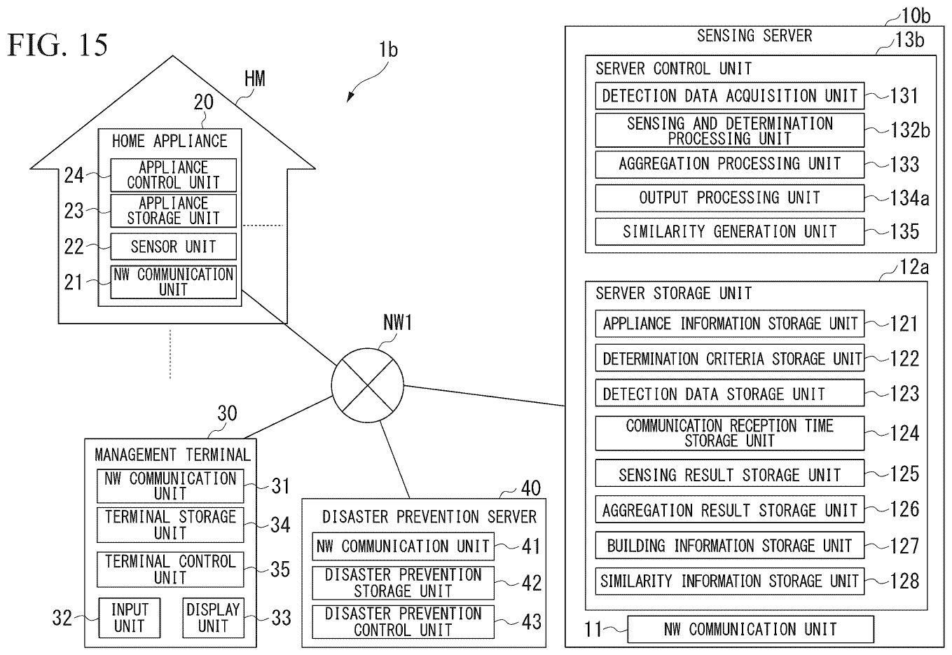

FIG. 15 is a functional block diagram showing an example of the sensing system 1b according to the third embodiment.

As shown in FIG. 15, the sensing system 1b includes a sensing server 10b, the home appliance 20, the management terminal 30, and the disaster prevention server 40.

In FIG. 15, the same components as the components shown in FIG. 12 described above are designated by the same reference numerals, and the description thereof will be omitted.

The sensing server 10b is a server device connectable to the home appliance 20 and the management terminal 30 via the network NW1. The sensing server 10b includes the NW communication unit 11, a server storage unit 12a, and a server control unit 13b.

The server storage unit 12a is, for example, a storage device such as a RAM, a flash memory, or an HDD, and stores various types of information used by the sensing server 10b. The server storage unit 12a stores, for example, a program for executing various types of processing of the sensing server 10b. In addition, the server storage unit 12b includes an appliance information storage unit 121, a determination criteria storage unit 122, the detection data storage unit 123, the communication reception time storage unit 124, the sensing result storage unit 125, the aggregation result storage unit 126, a building information storage unit 127, and a similarity information storage unit 128.

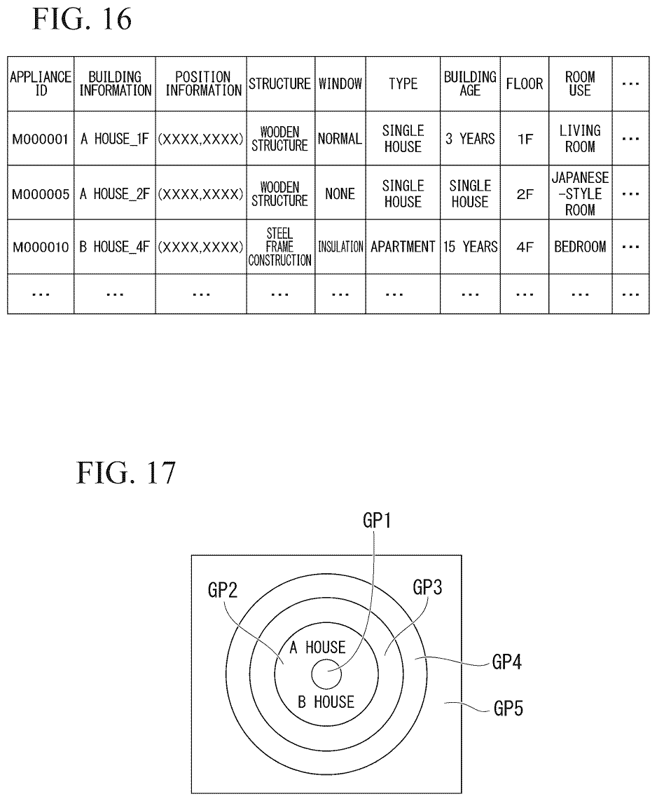

The building information storage unit 127 stores information related to the building HM in which the home appliance 20 is installed. Here, an example of data in the building information storage unit 127 will be described with reference to FIG. 16.

FIG. 16 is a diagram showing an example of data in the building information storage unit 127 in the present embodiment.

As shown in FIG. 16, the building information storage unit 127 stores the appliance ID, building information, position information, a structure, a window, a type, a building age, a floor, and room use in association with each other.

Here, the building information indicates, for example, a name of the building HM, and the position information indicates coordinate information based on a latitude and a longitude of the building HM. In addition, the structure indicates a structure of the building HM, the window indicates the presence or absence of a window and a structure, and the type indicates the type of the building HM. In addition, the building age indicates the number of years since construction of the building IHM, and the floor and room use indicate the floor and room in which the home appliance 20 is installed and the use of a room.

For example, in the example shown in FIG. 16, the building HM in which the home appliance 20 with the appliance ID “M00004” is installed has the building information “A house_1F” and the position information “(XXXX, XXXX)”. In addition, the building HM indicates that the structure is “wooden structure”, the window is “normal”, and the type is “single house”, In addition, the building HM indicates that the building age is “3 years”, the floor is “1F”, and the room use is “living room”.

Returning to the description of FIG. 15, the similarity information storage unit 128 stores the similarity generated by a similarity generation unit 135 described below. The calculation of the similarity will be described later.

The server control unit 13b is a functional unit that is implemented by causing a processor including, for example, a CPU to execute a program stored in the server storage unit 12a. The server control unit 13b includes the detection data acquisition unit 131, a sensing and determination processing unit 132b, the aggregation processing unit 133, an output processing unit 134a, and the similarity generation unit 135.

The similarity generation unit 135 generates a similarity between the building HM to be sensed and another building. The similarity generation unit 135 calculates the similarity based on, for example, the information stored in the building information storage unit 127.

The similarity generation unit 135 calculates the similarity by executing the following processing (1) to (5).
(1) The similarity generation unit 135 calculates the similarity based on the distance from the position information stored in the building information storage unit 127. The similarity generation unit 135 calculates the distance to the position information (latitude and longitude) of a target building to be compared, and groups the buildings by a certain distance based on the calculated distance as shown in FIG. 17. In the example shown in FIG. 17, the groups are grouped into a group GP1 to a group GP5 according to the distance.

The similarity generation unit 135 generates the similarity as “I” in a case of the group GP1 and similarity as “5” in a case of the group GP5.

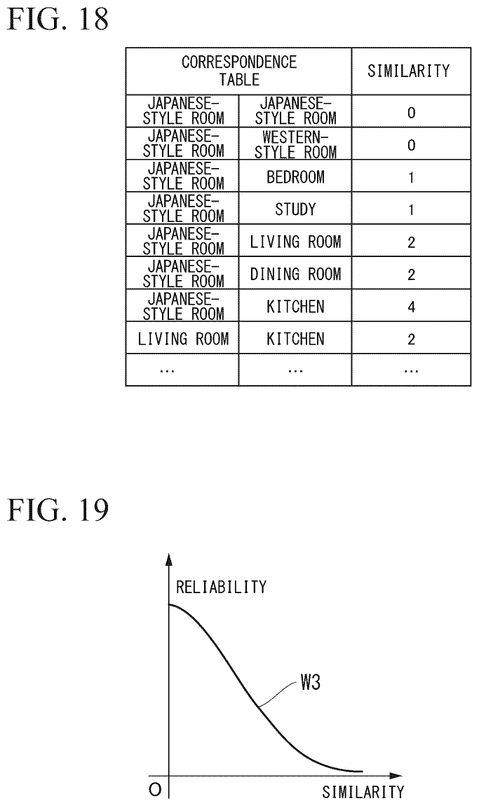

In FIG. 17, since a house A and a house B are grouped in the group GP2, the similarity generation unit 135 generates the similarity as the similarity “2”.
(2) The similarity generation unit 135 calculates the similarity from the information on the structure and the window stored in the building information storage unit 127. The similarity generation unit 135 generates the similarity as “0” when the information on the structure and the window match and generates the similarity as the similarity “1” when the information on the structure and the window do not match.
(3) The similarity generation unit 135 generates temporal and spatial similarity from the information on the building age and the floor stored in the building information storage unit 127. The similarity generation unit 135 calculates, as the similarity, the difference between the building age and the building age of the target building to be compared, and the difference between the floor and the floor of the target building to be compared.
(4) The similarity generation unit 135 calculates the similarity from the room use information stored in the building information storage unit 127 by using a quantification table. The similarity generation unit 135 generates a converted value as the similarity by using, for example, a quantification table (conversion table) as shown in FIG. 18,
(5) The similarity generation unit 135 calculates a square root of the similarity of some or all of the items of the similarities generated by the processing (1) to (5) described above to obtain a final similarity. The similarity generation unit 135 stores the generated similarity in the building information storage unit 127. In the present embodiment, the similarity is higher as the value is smaller, and the similarity is lower as the value is larger.

The sensing and determination processing unit 132b executes the same processing as the sensing and determination processing unit 132a of the second embodiment described above. In addition, when data is missing in the detection data in the determination period, the sensing and determination processing unit 132b complements the detection data in the determination period with detection data of another similar building based on the similarity with the building HM to be sensed. The sensing and determination processing unit 132b complements the detection data in the determination period based on the similarity generated by the similarity generation unit 135. For example, when the detection data is an outside air temperature detected by an outdoor unit of an air conditioner, the detection data can be complemented by using detection data of another building having a high degree of similarity.

In addition, the sensing and determination processing unit 132b calculates the reliability of the determination result of the presence or absence of a person based on the similarity. The sensing and determination processing unit 132b calculates the reliability from the similarity by using, for example, a waveform W3 as shown in FIG. 19.

FIG. 19 is a diagram showing an example of a relationship between the similarity and the reliability in the present embodiment.

The waveform W3 shown in FIG. 19 is a semi-normal distribution curve of a relationship between the similarity and the reliability. In the waveform W3, when the similarity is “0”, the reliability is “100%”.

The output processing unit 134a transmits the determination result and the reliability to the management terminal 30 via the NW communication unit 11. Since the other processing of the output processing unit 134a is the same as that of the output processing unit 134 of the first and second embodiments described above, the description thereof will be omitted here.

Next, an operation of the sensing system 1b according to the present embodiment will be described with reference to the drawings.

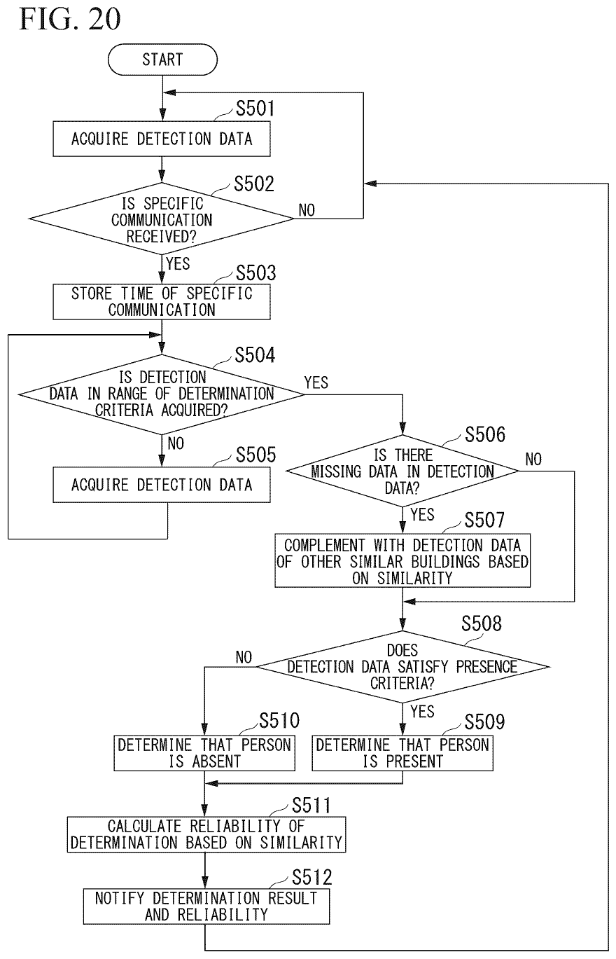

FIG. 20 is a flowchart showing an example of the presence/absence determination processing of a person, by the sensing server 10b in the present embodiment.

In FIG. 20, since the processing of steps S501 to S505 is the same as the processing of steps S201 to S205 shown in FIG. 10, the description thereof will be omitted here. In step S504, when the detection data of the determination period is acquired (YES in step S204), the sensing and determination processing unit 132b of the sensing server 10b advances the processing to step S506.

In step 3506, the sensing and determination processing unit 132b determines whether or not data is missing in the detection data. When data is missing in the detection data (YES in step S506), the sensing and determination processing unit 132b advances the processing to step S507. In addition, when any data is not missing in the detection data (NO in step S506), the sensing and determination processing unit 132b advances the processing to step S508.

In step S507, the sensing and determination processing unit 132b complements the detection data with the detection data of another similar building based on the similarity. The sensing and determination processing unit 132b complements the detection data with the detection data of another similar building by using the similarity generated by the similarity generation unit 135 through the processing (1) to (5) described above.

Since the processing of step S508 to step S510 is the same as the processing of step S206 to step S208 shown in FIG. 10 described above, the description thereof will be omitted here.

In addition, in step S511, the sensing and determination processing unit 132b calculates the reliability based on the similarity. The sensing and determination processing unit 132b calculates the reliability by using, for example, the waveform W3 shown in FIG. 19.

Next, the output processing unit 134a notifies the determination result and the reliability (step S512). The output processing unit 134a transmits the determination result corresponding to the appliance TD of the home appliance 20 stored in the sensing result storage unit 125 and the reliability calculated by the sensing and determination processing unit 132b to the management terminal 30 via the NW communication unit 11. After the processing of step S512, the output processing unit 134a returns the processing to step S501.

As described above, the sensing system 1b according to the present embodiment includes the detection data storage unit 123, the determination criteria storage unit 122, and the sensing and determination processing unit 132b (determination processing unit).

Accordingly, the sensing system 1b according to the present embodiment has the same effects as the first and second embodiments, and can accurately sense the presence or absence of a person in the building HM regardless of the magnitude of the power consumption of the home appliance 20.

In addition, in the present embodiment, when data is missing in the detection data in the determination period, the sensing and determination processing unit 132b complements the detection data in the determination period with detection data of another similar building based on the similarity with the building HM to be sensed.

As a result, even when data is missing in the detection data in the determination period, the sensing system 1b according to the present embodiment can sense the presence or absence of a person in the building HM.

In addition, in the present embodiment, the sensing and determination processing unit 132b calculates the reliability of the determination result of the presence or absence of a person based on the similarity.

Accordingly, in the sensing system 1b according to the present embodiment, the user can ascertain the reliability of the determination result of the presence or absence of a person, and can quantitatively determine the determination result of the presence or absence of a person,

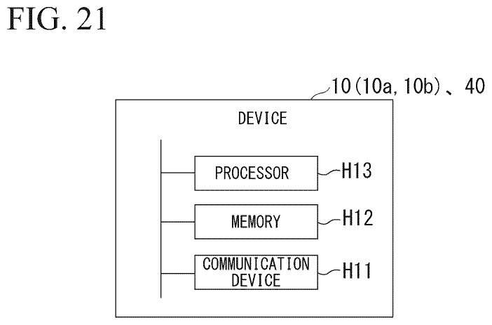

FIG. 21 is a diagram showing a hardware configuration of each device of the sensing systems 1 (1a, 1b).

The device shown in FIG. 21 shows a hardware configuration of each device (sensing server 10 (10a, 10b and disaster prevention server 40) of the sensing systems 1 (1a, 1b).

As shown in FIG. 21, each device (sensing server 10 (10a, 10b) and disaster prevention server 40) of the sensing systems 1 (1a, 1b) includes a communication device 1111, a memory 1112, and a processor 113.

The communication device H11 is, for example, a communication device connectable to the network NW1, such as a LAN card.

The memory 1112 is, for example, a storage device such as a RAM, a flash memory, or an HDD, and stores various types of information and programs used by each device (sensing server 10 (10a, 10b) and disaster prevention server 40).

The processor H13 is, for example, a processing circuit including a CPU. The processor H13 executes various types of processing of each device (sensing server 10 (10a, 10b) and disaster prevention server 40) by executing the program stored in the memory H12.

The present disclosure is not limited to each of the above-described embodiments, and can be modified without departing from the spirit and scope of the present disclosure.

For example, in each of the above-described embodiments, an example has been described in which the sensing server 10 (10a, 10b) is configured of one device, but the present invention is not limited thereto, and the sensing server 10 may be configured of a plurality of devices.

In addition, in each of the above-described embodiments, a specific communication may include, for example, a communication using a specific protocol, a communication using a specific communication port, and a communication having a feature in the communication data itself, in addition to an initial communication. In addition, the specific communication may be other communication that has a tendency different from the communication that occurs in common use.

In addition, in each of the above-described embodiments, an example has been described in which the aggregation processing unit 133 aggregates the detection data for each local government, but the present invention is not limited thereto, and for example, the aggregation may be performed in units such as an administrative division of either a prefecture or a city/town/village, a certain resolution of latitude and longitude, or regional information or block information with a specific distance as an aggregation axis.

In addition, in the second and third embodiments, the example has been described in which the disaster prevention server 40 is used as an example of an external device, but the present invention is not limited thereto, and a specific communication may be received from another external device.

In addition, in each of the above-described embodiments, the home appliance 20 is not limited to the appliance described in each of the above-described embodiments, and may be, for example, another home appliance, an IoT appliance, or the like.

In addition, in the third embodiment, the method of generating the similarity and the reliability is not limited to the method described in the embodiment, and another generation method may be applied.

Each configuration of the sensing systems 1 (1a, 1b) described above has a computer system inside. Then, a program for realizing the functions of each configuration of the sensing systems 1 (1a, 1b) may be recorded on a computer-readable recording medium, and the program recorded on the recording medium may be loaded into the computer system and executed to perform the processing in each configuration of the sensing systems 1 (1a. 1b). Here, the expression “the computer system loads the program recorded in the recording medium and executes the program” includes installing the program in the computer system. Here, the term “computer system” mentioned here includes an operating system (OS) and hardware such as a peripheral device.

In addition, the term “computer system” may include a plurality of computer devices connected via a network including a communication line such as the Internet, a WAN, a LAN, or a dedicated line. In addition, a term “computer-readable recording medium” refers to a storage device, for example, a portable medium such as a flexible disk, a magneto-optical disk, a ROM, or a CD-ROM, a hard disk built in a computer system, or the like, in this way, the recording medium on which the program is stored may be a non-transitory recording medium such as a CD-ROM.

Furthermore, the recording medium also includes an internal or external recording medium that is accessible by a distribution server for distributing the program. The program may be divided into a plurality of parts, each of which is downloaded at different times and then combined into each of the components provided by the sensing system 1 (1a, 1b), or each divided part of the program may be distributed by a different distribution server. Furthermore, the term “computer-readable recording medium” also includes a medium that holds the program for a certain period of time, such as a volatile memory (RAM) inside the computer system that serves as a server or a client in a case where the program is transmitted via a network. In addition, the program described above may be a program for realizing some of the functions described above. Furthermore, the program may be a so-called difference file (difference program) capable of implementing the functions described above in combination with a program that has already been recorded on the computer system.

### REFERENCE SIGNS LIST

1, 1a, 1b Sensing system
10, 10a, 10b Sensing server
11, 21, 31, 41 NW communication unit
12, 12a Server storage unit
13, 13a, 13b Server control unit
20 Home appliance
22 Sensor unit
23 Appliance storage unit
24 Appliance control unit
30 Management terminal
32 Input unit
33 Display unit
34 Terminal storage unit
35 Terminal control unit
40 Disaster prevention server
42 Disaster prevention storage unit
43 Disaster prevention control unit
121 Appliance information storage unit
122 Determination criteria storage unit
123 Detection data storage unit
124 Communication reception time storage unit
125 Sensing result storage unit
126 Aggregation result storage unit
127 Building information storage unit
128 Similarity information storage unit
131 Detection data acquisition unit
132, 132a, 132b Sensing and determination processing unit
133 Aggregation processing unit
134, 134a Output processing unit
135 Similarity generation unit
HM Building
NW1 Network

1-11. (canceled)

12. A sensing system comprising:
a detection data storage medium configured to store detection data detected by a home appliance installed in a building to be sensed, a detection time of the detection data, and appliance identification information for identifying the home appliance in association with each other;
a determination criteria storage medium configured to store determination criteria for determining presence or absence of a person in the building based on the detection data; and
determination processing circuitry that, when receiving a predetermined specific communication, is configured to determine presence or absence of a person in the building based on the detection data stored by the detection data storage medium, which is the detection data in a determination period based on a reception time at which the specific communication is received, and the determination criteria stored by the determination criteria storage medium, wherein
the determination processing circuitry is configured to determine presence or absence of a person in the building when receiving, as the specific communication, a communication that occurs when a user manually or automatically initializes a network setting after power supply to the home appliance is interrupted, and that is an initial communication for the home appliance to establish a communication with another device, from the home appliance.

13. The sensing system according to claim 12, wherein
the determination processing circuitry is configured to determine presence or absence of a person in the building when receiving, as the specific communication, a regular communication between the home appliance and another device from the home appliance.

14. The sensing system according to claim 13, wherein
the determination processing circuitry is configured to determine that the specific communication is received and determine presence or absence of a person in the building when the regular communication is received from the home appliance and a change per unit time equal to or greater than a threshold occurs in the detection data.

15. The sensing system according to claim 12, wherein
the determination processing circuitry is configured to determine presence or absence of a person in the building when receiving, as the specific communication, a specific notification communication that notifies specific notification information from an external device different from the home appliance.

16. The sensing system according to claim 12, wherein
when receiving a plurality of the specific communications in a predetermined certain period, the determination processing circuitry is configured to determine presence or absence of a person in the building by using the detection data in a determination period based on a median value or a most recent value among a plurality of the reception times.

17. The sensing system according to claim 12, wherein
when data is missing in the detection data in the determination period, the determination processing circuitry is configured to complement the detection data in the determination period with the detection data from another similar building based on a similarity with the building to be sensed.

18. The sensing system according to claim 17, wherein
the determination processing circuitry is configured to calculate a reliability of a determination result of presence or absence of a person based on the similarity.

19. The sensing system according to claim 12, further comprising a server device connectable to the home appliance via a network, wherein
the server device includes:
the detection data storage medium;
the determination criteria storage medium;
the determination processing circuitry; and
output processing circuitry configured to output a determination result determined by the determination processing circuitry to a terminal device connectable to the server device via the network.

20. The sensing system according to claim 19, further comprising:
aggregation processing circuitry configured to generate an aggregation result obtained by aggregating the determination result determined by the determination processing circuitry for each predetermined area, wherein
the output processing circuitry is configured to output the aggregation result to the terminal device.

21. A sensing system comprising:
a detection data storage medium configured to store detection data detected by a home appliance installed in a building to be sensed, a detection time of the detection data, and appliance identification information for identifying the home appliance in association with each other;
a determination criteria storage medium configured to store determination criteria for determining presence or absence of a person in the building based on the detection data; and
determination processing circuitry that, when receiving a predetermined specific communication, is configured to determine presence or absence of a person in the building based on the detection data stored by the detection data storage medium, which is the detection data in a determination period based on a reception time at which the specific communication is received, and the determination criteria stored by the determination criteria storage medium, wherein
when data is missing in the detection data in the determination period, the determination processing circuitry is configured to complement the detection data in the determination period with the detection data from another similar building based on a similarity with the building to be sensed.

22. A sensing method of a sensing system including
a detection data storage medium configured to store detection data detected by a home appliance installed in a building to be sensed, a detection time of the detection data, and appliance identification information for identifying the home appliance in association with each other, and
a determination criteria storage medium configured to store determination criteria for determining presence or absence of a person in the building based on the detection data, the sensing method comprising:
determining, via determination processing circuitry, when receiving a predetermined specific communication, presence or absence of a person in the building based on the detection data stored by the detection data storage medium, which is the detection data in a determination period based on a reception time at which the specific communication is received, and the determination criteria stored by the determination criteria storage medium, wherein
in determining presence or absence of a person in the building, the determination processing circuitry is configured to determine presence or absence of a person in the building when receiving, as the specific communication, a communication that occurs when a user manually or automatically initializes a network setting after power supply to the home appliance is interrupted, and that is an initial communication for the home appliance to establish a communication with another device, from the home appliance.

23. A sensing method of a sensing system including
a detection data storage medium configured to store detection data detected by a home appliance installed in a building to be sensed, a detection time of the detection data, and appliance identification information for identifying the home appliance in association with each other, and
a determination criteria storage medium configured to store determination criteria for determining presence or absence of a person in the building based on the detection data, the sensing method comprising:
determining, via determination processing circuitry, when receiving a predetermined specific communication, presence or absence of a person in the building based on the detection data stored by the detection data storage medium, which is the detection data in a determination period based on a reception time at which the specific communication is received, and the determination criteria stored by the determination criteria storage medium, wherein
in determining presence or absence of a person in the building, when data is missing in the detection data in the determination period, the determination processing circuitry is configured to complement the detection data in the determination period with the detection data from another similar building based on a similarity with the building to be sensed.
